(19) United States
(12) Patent Application Publication
(10) Pub. No.: US 2026/0320286 A1
(43) Pub. Date: Oct. 15, 2026

(54) INTERACTIVE CONTENT GENERATION METHOD AND APPARATUS, INTERACTIVE CONTENT DISPLAY METHOD AND APPARATUS, AND ELECTRONIC DEVICE

(71) Applicant: Beijing Zitiao Network Technology Co., Ltd., Beijing (CN)

(72) Inventor: Zhanpeng SUN, Beijing (CN)

(21) Appl. No.: 19/483,594

(22) PCT Filed: Jul. 26, 2024
(86) PCT No.: PCT/CN2024/107775

§ 371 Date: Nov. 11, 2025

(30) Foreign Application Priority Data
Mar. 25, 2024 (CN) 202410346488.7

(51) Int. Cl. G06F 40/166; G06F 3/0483; G06F 3/04842

(52) U.S. Cl. CPC G06F 40/166; G06F 3/0483; G06F 3/04842

(57) ABSTRACT

Embodiments of the present disclosure provide an interactive content generation method and apparatus, an interactive content display method and apparatus, and an electronic device. The interactive content generation method includes: displaying a content editing page: determining at least one character in target interactive content, the at least one character includes at least one virtual character: generating. on the content editing page. text content associated with the at least one character; determining a user character in the at least one character to enable a user to chat with the at least one virtual character according to the user character; and generating the target interactive content based on the virtual character, the user character, and the text content, and publishing the target interactive content.

The present application claims priority to and benefits of the Chinese Patent Application No. 202410346488.7, filed on Mar. 25, 2024, which is incorporated herein by reference in its entirety as a part of the present application.

### TECHNICAL FIELD

Embodiments of the present disclosure relate to an interactive content generation method, an interactive content display method, an interactive content generation apparatus, an interactive content display apparatus, and an electronic device.

### BACKGROUND

With the development of artificial intelligence and natural language processing technologies, virtual characters can be created and users can interact with the virtual characters using natural language.

The interaction between a user and a virtual character may, for example, be a chat performed between the user and the virtual character in a chat interface.

### SUMMARY

Embodiments of the present disclosure provide an interactive content generation method and apparatus, an interactive content display method and apparatus, and an electronic device.

According to a first aspect, an embodiment of the present disclosure provides an interactive content generation method. The method includes: displaying a content editing page; determining at least one character in target interactive content, where the character includes at least one virtual character; generating, on the content editing page, text content associated with the at least one character; determining a user character in the at least one character to enable a user to chat with the at least one virtual character according to the user character; and generating the target interactive content based on the virtual character, the user character, and the text content, and publishing the target interactive content.

According to a second aspect, an embodiment of the present disclosure provides an interactive content display method. The method includes: displaying, in response to a trigger operation performed by a second user on published target interactive content, a display interface for the target interactive content; and displaying, in the display interface for the target interactive content, information about the target interactive content and information about at least one target virtual character associated with the target interactive content, where the at least one target virtual character has a public character attribute, and the target virtual character supports chatting with a user beyond the target interactive content.

According to a third aspect, an embodiment of the present disclosure provides an interactive content generation apparatus. The apparatus includes: a first display unit, configured to display a content editing page; a first determination unit, configured to determine at least one character in target interactive content, where the at least one character includes at least one virtual character; a first generation unit, configured to generate, on the content editing page, text content associated with the at least one character; a second determination unit, configured to determine a user character in the at least one character to enable a user to chat with the at least one virtual character according to the user character; and a second generation unit, configured to generate the target interactive content based on the virtual character, the user character, and the text content, and publish the target interactive content.

According to a fourth aspect, an embodiment of the present disclosure provides an interactive content display apparatus. The apparatus includes: a second display unit, configured to display, in response to a trigger operation performed by a second user on published target interactive content, a display interface of the target interactive content; and a third display unit, configured to display, in the display interface of the target interactive content, information about the target interactive content and information about at least one target virtual character associated with the target interactive content, where the at least one target virtual character has a public character attribute, and the target virtual character supports chatting with a user beyond the target interactive content.

According to a fifth aspect, an embodiment of the present disclosure provides an electronic device. The electronic device includes: a processor and a memory,
where the memory stores computer-executable instructions; and
the processor executes the computer-executable instructions stored in the memory, to cause the processor to perform the methods according to the first and second aspects and various possible designs of the first and second aspects.

According to a sixth aspect, an embodiment of the present disclosure provides a computer-readable storage medium, the computer-readable storage medium stores computer-executable instructions, when a processor executes the computer-executable instructions, the methods according to the first and second aspects and various possible designs of the first and second aspects are implemented.

According to a seventh aspect, an embodiment of the present disclosure provides a computer program product including a computer program that, when executed by a processor, causes the methods according to the first and second aspects and various possible designs of the first and second aspects to be implemented.

### BRIEF DESCRIPTION OF DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a first schematic flowchart of an interactive content generation method according to the present disclosure;

FIG. 2 is a second schematic flowchart of an interactive content generation method according to the present disclosure;

FIG. 3 is a schematic diagram of an application scenario;

FIG. 4 is a schematic diagram of an application scenario;

FIG. 5 is a schematic diagram of an application scenario;

FIG. 6 is a schematic flowchart of an interactive content display method according to the present disclosure;

FIG. 7 is a schematic structural diagram of an interactive content generation apparatus according to the present disclosure;

FIG. 8 is a schematic structural diagram of an interactive content display apparatus according to the present disclosure; and

FIG. 9 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

Interactive content refers to content that is interactive, and there may be one or more characters (the one or more characters here may include a virtual character) in the interactive content (such as an interactive story). The plot of the interactive content may be set in advance. A second user engaging in the interactive content (a participant user of the interactive content) drives the development of the plot of the interactive content through chats between the second user and the virtual character and/or between virtual characters. This interactivity enhances the user's sense of engagement, control, and enjoyment, while also increasing the complexity of the story.

Interactive content is typically created by developers, including the characters, scenes, plots, etc. of the interactive content, all of which are created by developers. Users may engage in the interactive content after the interactive content is published.

In some application scenarios, users also have the need to create interactive content.

The embodiments provide an interactive content generation method and apparatus, an interactive content display method and apparatus, and an electronic device, which provide a new interactive content generation mode by: displaying a content editing page; determining at least one character in target interactive content, where the character includes at least one virtual character; generating, on the content editing page, text content associated with the at least one character; determining a user character in the at least one character to enable a user to chat with the at least one virtual character according to the user character; and generating the target interactive content based on the virtual character, the user character, and the text content, and publishing the target interactive content. When editing interactive content, this approach involves associating characters, including a virtual character and a user character, with the interactive content, and generating interactive content based on text content associated with the character. This facilitates improving the efficiency of interactive content generation and meeting the user's needs for creating interactive content.

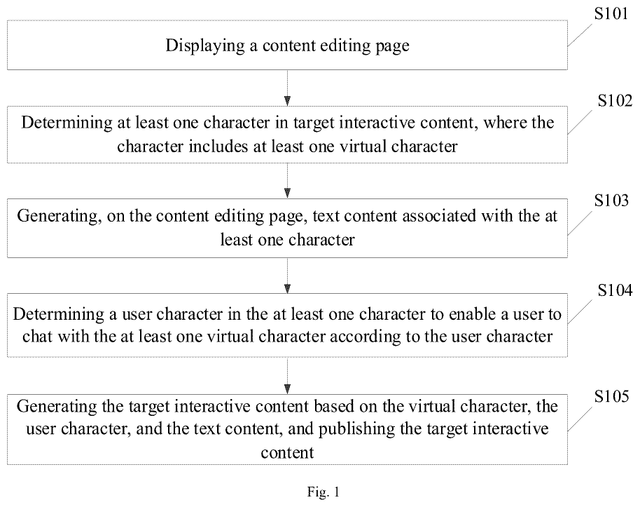

Referring to FIG. 1, FIG. 1 is a first schematic flowchart of an interactive content generation method according to the present disclosure. As shown in FIG. 1, the method includes the following steps.
S101: Displaying a content editing page.

In this embodiment, an execution body of the interactive content generation method may be a terminal device, in particular an application client running in the terminal; or it may be a server.

A creator (hereinafter referred to as a first user) of interactive content may send a content editing page launch instruction to the execution entity, and then the execution body may display the content editing page.

In the present disclosure, the terminal device of the first user may generate and publish the interactive content based on operations of the first user. In addition, after the interactive content is published, the application client of a user (e.g., a participant user) may display the published interactive content to the user, enabling the user to engage in the published interactive content.

Specifically, an interactive content creation control may be displayed in the application client displayed to the first user. The first user may perform a trigger operation on the interactive content creation control to display the content editing page.

The content editing page may include a plurality of content editable items for the interactive content. The plurality of content editable items for the interactive content include, but are not limited to, a character editing item, an interactive content editing item, etc.

The creator of the interactive content may issue to the terminal device an instruction to display the interactive content editing page, thereby displaying the content editing page. The content editing page is configured to edit text content and characters corresponding to target interactive content.
S102: Determining at least one character in target interactive content, where the character includes at least one virtual character.

As an implementation, the execution body may determine the at least one character in the target interactive content based on character setting operations of the user.

The at least one character may include the at least one virtual character. The virtual character (fiction character) is a fictional character, a human image (a virtual figure) or a non-human image (such as a virtual animal) that does not exist in reality.
S103: Generating, on the content editing page, text content associated with the at least one character.

As an implementation, the text content associated with the at least one character may be generated based on input operations of the first user on the content editing page.

As another implementation, the text content associated with the at least one character is generated by triggering a text content generation model on the content editing page. The text content generation model here may be a generative natural language processing model, such as various types of neural network models.

The text content here may include storylines of the target interactive content, such as the dialog and plot.
S104: Determining a user character in the at least one character to enable a user to chat with the at least one virtual character according to the user character.

One or more user characters are specified in the at least one character, and the at least one virtual character that can interact with the one or more user characters is set. After the target interactive content is published, the user may chat with the at least one virtual character in the character in the target interactive content according to the user character.
S105: Generating the target interactive content based on the virtual character, the user character, and the text content, and publishing the target interactive content.

Specifically, the target interactive content may be generated after the virtual character, the user character, and the text content of the target interactive content are determined. For example, the target interactive content may be generated based on the virtual character, the user character, and the text content of the target interactive content in response to receiving a trigger operation performed by the first user on an interactive content generation control on the content editing page. The target interactive content may further be published according to a publishing instruction sent by the first user.

Here, publishing the target interactive content means displaying the target interactive content to a plurality of participant users who use the application client.

In this embodiment, the content editing page is displayed; the at least one character in the target interactive content is determined, where the character includes at least one virtual character; the text content associated with the at least one character is generated on the content editing page; the user character in the at least one character is determined to enable the user to chat with the at least one virtual character according to the user character; and the target interactive content is generated based on the virtual character, the user character, and the text content, and the target interactive content is published. Therefore, an interactive content generation approach that meets the user's needs for creating interactive content is provided. When editing interactive content, this approach involves associating characters, including a virtual character and a user character, with the interactive content, and generating interactive content based on text content associated with the characters, thereby providing convenience for the user in creating interactive content.

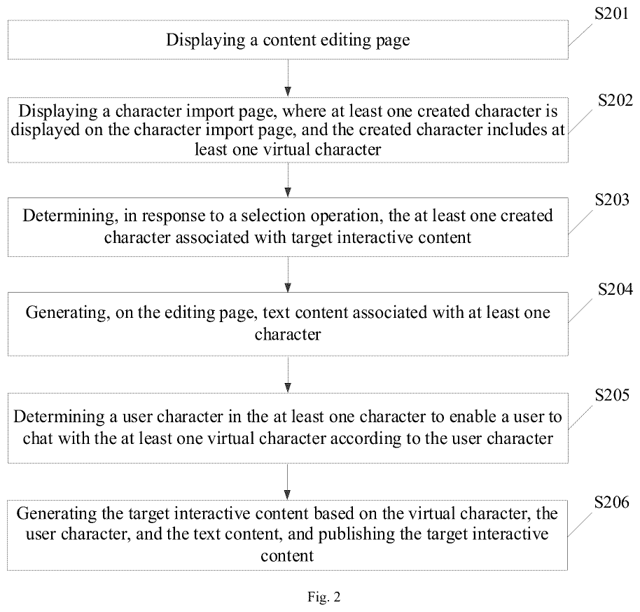

Referring to FIG. 2, FIG. 2 is a second schematic flowchart of an interactive content generation method according to the present disclosure. As shown in FIG. 2, the method includes the following steps.
S201: Displaying a content editing page.

For detailed implementation of the above-mentioned step S201, reference may be made to step S101 of the embodiment shown in FIG. 1, which will not be repeated here.
S202: Displaying a character import page, where at least one created character is displayed on the character import page, and the created character includes at least one virtual character.

In this embodiment, an execution body of the interactive content generation method may be a terminal device, in particular an application client running in the terminal device.

The content editing page may include a character import control. The character import control is configured to import the created character in the application. The character import page may be displayed based on a received trigger operation on the character import control.

The created character here may be a character historically created by the first user; or the created character may be a character historically created by another creator and available to the first user. The created character may have character attributes that are historically set.

The at least one created character includes the at least one virtual character.
S203: Determining, in response to a selection operation, the at least one created character associated with target interactive content.

After the at least one created character is displayed in the character import interface in step S202, the first user may perform the selection operation on one or more created characters displayed in the character import interface. The execution body may use the one or more created characters indicated by the selection operation as the created character associated with the target interactive content.

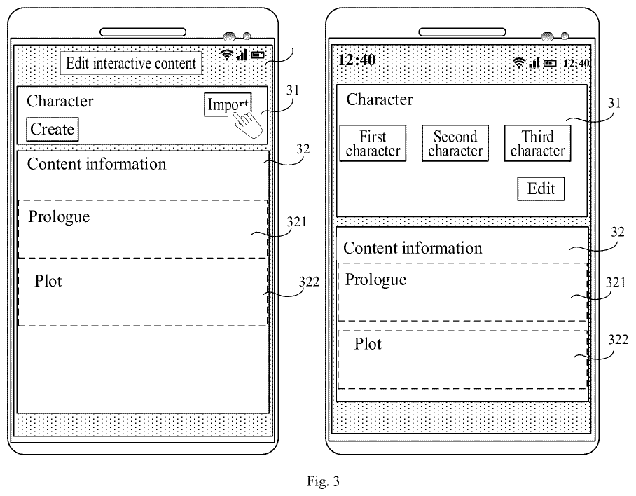

Referring to FIG. 3, FIG. 3 is a schematic diagram of an application scenario. As shown in FIG. 3, a plurality of content editable items for the interactive content are displayed on the content editing page 30, including: characters, content information, etc. The content editing page 30 includes a character editing region 31 and a content information editing region 32. The content information editing region 32 may include a prologue setting region 321 and a plot setting region 322.

The character editing region 31 may include an import control 31. The first user may perform a trigger operation on the character import control 31 to display a character list, as shown in the right panel of FIG. 3. The character list includes existing characters: a first character, a second character, and a third character. The first user may perform the selection operation on the first character to import the first character into the target interactive content.
S204: Generating, on the content editing page, text content associated with the at least one character.

In this embodiment, the text content associated with the at least one character, including the created character, may be generated on the content editing page.

For example, the text content associated with the at least one character, including the created character, is generated based on a text content editing operation of the user.

For another example, the text content associated with the at least one character is generated by invoking a text content generation model on the content editing page, etc.
S205: Determining a user character in the at least one character to enable a user to chat with the at least one virtual character according to the user character.
S206: Generating the target interactive content based on the virtual character, the user character, and the text content, and publishing the target interactive content.

For detailed implementation of the above-mentioned steps S205 and S206, reference may be made to relevant descriptions of steps S104 and S105 in the embodiment shown in FIG. 1, which will not be repeated here.

In this embodiment, a description is provided of displaying a character import page including the created character, and determining the created character associated with the target interactive content based on the selection operation, such that the target interactive content is associated with the created character, and the created character associated with the target content can be used in the target interactive content, which can eliminate the need for the creation operation of characters when editing the interactive content, thereby improving the efficiency of interactive content generation.

In some embodiments, the character includes a character attribute. After the above-mentioned step S203, the method further includes the following steps.

First, receiving an additional character attribute of the created character.

Then, generating the character attribute of the created character in the target interactive content based on at least one of the additional character attribute and a public character attribute of the character.

Characters having the public attribute can be referenced by a plurality of pieces of interactive content, and can also support independent chatting with a user beyond the interactive content. The public character attribute of the above-mentioned created character may be a character attribute that the created character has before being imported into the target interactive content. The public attribute of the created character may be a public character attribute that is set in other interactive content; or it may be a public character attribute that is configured in a public character editing interface provided by the application beyond any interactive content.

The above-mentioned additional character attribute may be a character attribute that is configured for the created character in the target interactive content. For example, it may be a character attribute that is input by the first user through the content editing page for the above-mentioned target interactive content.

In some application scenarios, the character attribute of the created character in the target interactive content may be generated based on the additional character attribute. As a schematic illustration, additional character attributes are configured for a plurality of character attribute items of the created character, and the character attribute of the created character in the above-mentioned target interactive content may be generated based on the additional character attributes of the plurality of character attribute items.

In some application scenarios, the character attribute of the above-mentioned created character may be generated based on the public character attributes respectively corresponding to the plurality of character attribute items according to a character attribute configuration operation of the first user. For example, the character attribute of the created character is generated using the public character attributes respectively corresponding to the plurality of character attribute items according to the selection of the user.

In some application scenarios, in the above-mentioned target interactive content, additional character attributes are configured for a part of the character attribute items. In these application scenarios, the additional character attributes of the part of the character attribute items and the public character attributes of the other character attribute items can be used together to generate the character attribute of the created character in the target interactive content. Specifically, the original public character attributes of the part of the character attribute items may be replaced with the additional character attributes of the part of the character attribute items, while retaining the original public character attributes of the other character attribute items, thereby generating the character attribute of the created character.

In some embodiments, the created character has a plurality of character attribute items, the plurality of character attribute items each having a public character attribute; and the additional character attribute includes additional character attributes of one or more character attribute items. The generating the character attribute of the created character in the target interactive content based on the additional character attribute and/or the public character attribute of the character includes:
determining, for any character attribute item having an additional character attribute, whether the additional character attribute and a public character attribute corresponding to the character attribute item meet a preset condition; and if the additional character attribute and the public character attribute corresponding to the character attribute item meet the preset condition, generating a character attribute corresponding to the character attribute item based on the additional character attribute and the public character attribute;
otherwise generating the character attribute corresponding to the character attribute item based on the additional character attribute.

In these embodiments, the plurality of character attribute items of the created character may include, for example: a character image, a character name, a character story, a character type, a character sound, etc. Each of the character attribute items above may have a corresponding public character attribute before the character attribute item is imported into the target interactive content.

On the content editing page for the target interactive content, the additional character attributes may be configured for the one or more character attribute items based on the character attribute configuration operation of the user.

When specific character attributes of the character attribute items in the target interactive content are determined, it can be detected, for any character attribute item, whether the character attribute item has an additional character attribute. If the character attribute item has no additional character attribute, a public character attribute corresponding to the character attribute item is used as the character attribute of the character attribute item in the target interactive content.

If a character attribute item has an additional character attribute, there is a need to further determine whether the additional character attribute and the public character attribute meet the preset condition. If the additional character attribute and the public character attribute meet the preset condition, the additional character attribute and the public character attribute may be integrated to obtain an integrated result as the character attribute of the character attribute item.

As an implementation, the preset condition may be, for example, that there is no conflict between the additional character attribute and the public character attribute. Specifically, a character attribute conflict rule may be set in advance, such that whether there is a conflict between the additional character attribute and the public character attribute can be determined using the character attribute conflict rule.

If the additional character attribute corresponding to the character attribute item and the public character attribute corresponding to the character attribute item do not meet the preset condition, the character attribute corresponding to the character attribute item is generated based on the additional character attribute.

Illustratively, the character attribute item of the created character that has an additional character attribute may be, for example, the character image. The public character attribute of the character image being “lively” is used as an example. If the additional character attribute is “cheerful”, it can be determined that the public character attribute and the additional character attribute meet the preset condition, and then the public character attribute “lively” and the additional character attribute “cheerful” may be combined into the character attribute “lively and cheerful” of the character image of the created character.

If the additional character attribute is “quiet”, there is a conflict between the public character attribute and the additional character attribute, indicating a failure to meet the preset condition. Then, the character attribute of the character image of the created character in the target interactive content may be generated using the additional character attribute “quiet”.

In these embodiments, for a character attribute item having an additional character attribute, it can be determined, depending on whether the additional character attribute and the public character attribute meet the preset condition, whether the character attribute of the character attribute item is generated based on a combination of the additional character attribute and the public character attribute or based on the additional character attribute, so as to determine the character attribute of each character attribute item in the target interactive content. When there is no conflict between the additional character attribute and the public character attribute, the additional character attribute and the public character attribute may be integrated into the character attribute of the character attribute item in the target interactive content. The generated character attribute of the character attribute item has the additional character attribute added to the public attribute. When there is a conflict between the additional character attribute and the public character attribute, the character attribute corresponding to the character attribute item is generated using the additional character attribute. In this way, the character attribute of the character attribute item in the target interactive content matches the requirement in the target interactive content.

In some embodiments, the method further includes:
updating, in response to publishing the target interactive content, the public character attribute of the created character to the character attribute in the target interactive content.

In these embodiments, after the target interactive content is published, the public character attribute of the created character may be updated to the character attribute in the target interactive content. That is, the character attribute of the created character beyond the target interactive content is updated to the character attribute of the created character in the target interactive content. In this way, consistent character attributes of the created character in the target interactive content and beyond the target interactive content are achieved.

In some embodiments, the interactive content generation method further includes the following step:
displaying a character creation page, and determining, in response to a creation operation, at least one newly created character associated with the text content.

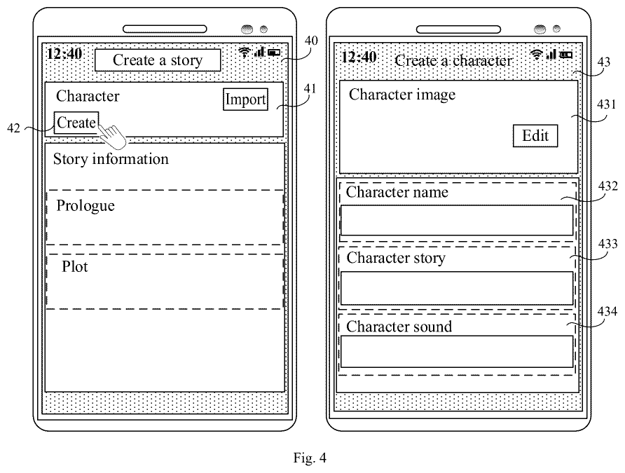

Referring to FIG. 4, FIG. 4 is a schematic diagram of an application scenario. As shown in FIG. 4, the content editing page 40 further includes a creation control 42 for creating a character. The creation control may be provided on the content editing page 40, including the character editing region 41. The user may perform a trigger operation on the creation control 42 to display the character creation page 43. On the character creation page 43, a plurality of character attribute items may be displayed, such as a character image, a character name, a character sound, a character story, and a character type.

Each character attribute item may correspond to one editing region. Fox example, as shown in FIG. 4, the character image corresponds to an editing region 431, the character name corresponds to an editing region 432, the character story corresponds to an editing region 433, and the character sound corresponds to an editing region 434. In some application scenarios, the public attribute of each character attribute item of the created character may be displayed in the editing region corresponding to the character attribute item. For any character attribute item, an additional character attribute may be edited in the editing region for the character attribute item.

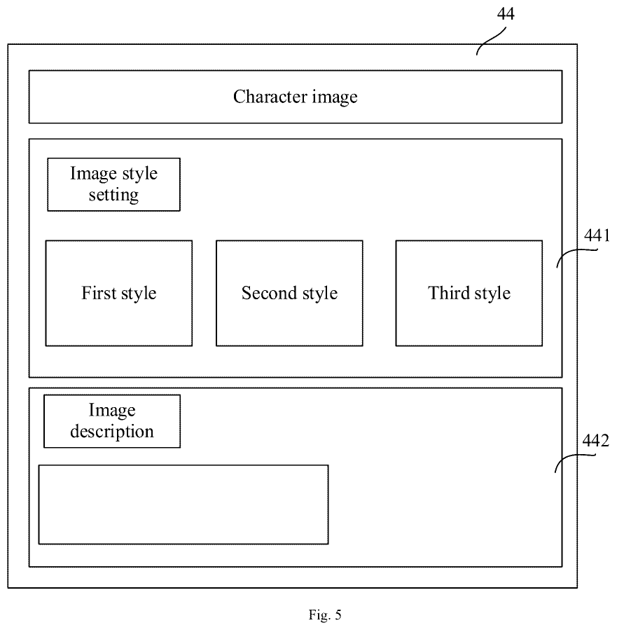

For example, the public character attribute “first image” corresponding to the character image and the edit control may be displayed in the editing region 431. A character image editing interface may be displayed in response to receiving a trigger operation performed on the edit control. As shown in FIG. 5, the character image editing interface 44 includes character image editing items such as “image setting” and “image description”. One or more selectable styles, such as a “first style”, a “second style”, and a “third style”, may be displayed in the editing region 441 for image style settings in the character image editing items. A selection operation may be performed on the one or more selectable image styles to select an image style.

The character image editing interface 44 may further include an editing region 442 for image descriptions, to allow input of image descriptions.

The description information of the image may be edited in the editing region 442 for image descriptions.

After the character image style is selected and the character image description information is written in the character image editing interface 44, a generation and confirmation control in the character editing interface 44 may be clicked. After the confirmation control is clicked, a character image may be generated.

In these embodiments, the characters are created for the interactive content through a character creation operation, such that the characters can be created in the interactive content as needed, enabling flexible creation of the characters.

In some embodiments, step S103 in the embodiment shown in FIG. 1 and step S204 in the embodiment shown in FIG. 2 include:
displaying, after or during generating the text content, the at least one character on the content editing page, and inserting a target character into the text content in response to a selection operation to associate the target character with the text content;
or on the content editing page, inserting, after or during generating the text content, the target character into the text content in response to an input operation for a name or an identifier of the target character to associate the target character with the text content.

In some application scenarios, the text content, including the prologue and plots, may be edited in the content information editing region 32 shown in FIG. 3. After the text content is edited, at least one character may be displayed. The at least one character here includes one or more of an imported created character, a newly created character, and a user character.

A selection operation may be performed on the at least one character that is displayed, such as a click or touch operation performed on the target character in the at least one character. After the selection operation is received, the target character indicated by the selection operation may be inserted into the text content, for example, into a specified position of the text content.

Illustratively, the text content may be edited in the content information editing region shown in FIG. 3. During the process of editing the text content, at least one character, such as one or more of the imported created character, the newly created character, and the user character, is displayed. A selection operation may be performed on the at least one character that is displayed, to insert the target character indicated by the selection operation into a specified position of the text content, for example, into the current position of a cursor.

As a schematic illustration, the at least one character may be displayed above a text content input box for inputting text content in a content information region 32.

In these application scenarios, at least one character is displayed after or during the process of editing the text content, and a selected character is inserted into the text content through a selection operation, such that an imported character and/or a newly created character can be directly inserted into the text content, thereby improving the efficiency of inserting characters into the text content.

In some application scenarios, the name or the identifier of the target character may be input when the interactive content is edited (e.g., the prologue and plots are edited) in the content information editing region 32 as shown in FIG. 3. After the input name or identifier of the target character is received, the target character may be inserted into a target position of the text content. The target position here may be a position indicated by the cursor.

The name or the identifier of the target character may include numbers, text, and/or symbols, etc. The name or the identifier of the target character can distinguish between different characters.

In these application scenarios, the target character can be inserted into the target interactive content according to the user's needs by inserting the target character into the text content based on an input operation for the name or the identifier of the target character.

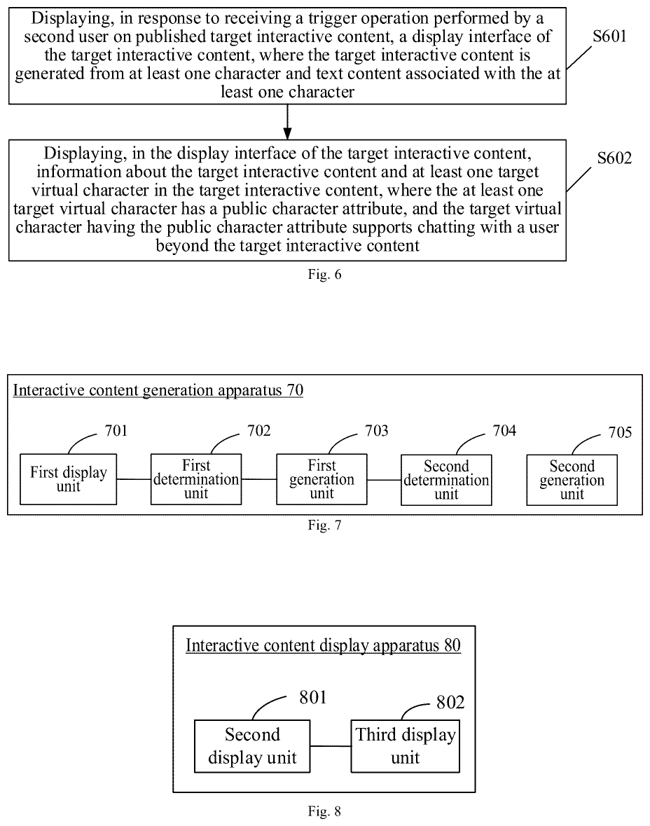

Referring to FIG. 6, FIG. 6 is a schematic flowchart of an interactive content display method according to the present disclosure. As shown in FIG. 6, the method includes the following steps.
S601: Displaying, in response to receiving a trigger operation performed by a second user on published target interactive content, a display interface of the target interactive content, where the target interactive content is generated from at least one character and text content associated with the at least one character.
S602: Displaying, in the display interface of the target interactive content, information about the target interactive content and at least one target virtual character in the target interactive content, where the at least one target virtual character has a public character attribute, and the target virtual character having the public character attribute supports chatting with a user beyond the target interactive content.

In this embodiment, an execution body of the interactive content display method may be an application client or a server.

The target interactive content here may be target interactive content that has been published. The second user may be any user who logs into the application client and browses the published target interactive content. The second user may be a participant user who uses the target interactive content after it is published. The second user may open a display interface for the target interactive content through the trigger operation. The trigger operation may be, for example, a click or touch operation performed on the name or the identifier of the target interactive content, to enter the display interface for the target interactive content.

The target interactive content includes a plurality of characters associated with the target interactive content, including an imported created character and a newly created character during the process of editing the target interactive content.

In the target interactive content, the participant user may engage as the user character in the target interactive content, and perform information interaction with the fiction characters and/or other user characters in the target interactive content to drive the development of the plot of the target interactive content.

The above-mentioned characters may include virtual characters and user characters. Some virtual characters may have public character attributes. The virtual characters having the public character attributes may be target virtual characters.

Since the target virtual characters have public attributes, these target virtual characters can be applied to other interactive content, or support independent chatting with these characters beyond the interactive content.

At least one target virtual character associated with the target interactive content may be displayed in the display interface for the target interactive content.

In some embodiments, the method further includes the following step:
displaying a first chat interface independent of the target interactive content in response to receiving an independent chat request initiated by the second user for the target virtual character, where the first chat interface is configured for the second user to have a chat, that is independent of the target interactive content , with the target virtual character.

In these embodiments, the second user may initiate an independent chat request for any target virtual character displayed in the display interface for the target interactive content. For example, an independent chat request may be sent by performing a click operation on a name or an identifier of a target virtual character. The independent chat request is used for requesting an independent chat with the target virtual character that is independent of the target interactive content.

After the independent chat request is received, the first chat interface may be displayed. The first chat interface here may be a chat interface between the target virtual character and the second user. In the first chat interface, the second user may start chatting with the target virtual character that is not related to the target interactive content. Therefore, for a target virtual character having a public character attribute, the second user may initiate, in the interactive content that references the target virtual character, chatting with the target virtual character that is independent of the interactive content.

In this embodiment, when a participant user of the target interactive content uses the target interactive content, at least one target virtual character having a public character attribute is presented to the participant user, such that the participant user can initiate an independent chat with the target virtual character in the target interactive content, thereby providing convenience for the participant user.

Corresponding to the interactive content generation method described above in the embodiment shown in FIG. 1, FIG. 7 is a structural block diagram of an interactive content generation apparatus according to an embodiment of the present disclosure. For ease of illustration, only parts related to this embodiment of the present disclosure are shown. Referring to FIG. 7, the apparatus 70 includes: a first display unit 701, a first determination unit 702, a first generation unit 703, a second determination unit 704, and a second generation unit 705.

The first display unit 701 is configured to display a content editing page.

The first determination unit 702 is configured to determine at least one character in target interactive content, where the at least one character includes at least one virtual character.

The first generation unit 703 is configured to generate, on the content editing page, text content associated with the at least one character.

The second determination unit 704 is configured to determine a user character in the at least one character to enable a user to chat with the at least one virtual character according to the user character.

The second generation unit 705 is configured to generate the target interactive content based on the virtual character, the user character, and the text content, and publish the target interactive content.

In some embodiments, the first determination unit 702 is further configured to:
display a character import page, where at least one created character is displayed on the character import page; and
determine, in response to a selection operation, the at least one created character associated with the target interactive content.

In some embodiments, the character includes character attributes. The first determination unit 702 is further configured to:
receive an additional character attribute of the created character; and
generate the character attribute of the created character in the target interactive content based on at least one of the additional character attribute and a public character attribute of the character.

In some embodiments, the apparatus 70 further includes an update unit (not shown in the figure) configured to: update, in response to publishing the target interactive content, the public character attribute of the created character to the character attribute in the target interactive content.

In some embodiments, the created character has a plurality of character attribute items, each character attribute item of the plurality of character attribute items has a public character attribute, and the additional character attribute includes additional character attributes of one or more character attribute items. The first determination unit 702 is further configured to:
determine, for any character attribute item having an additional character attribute, whether an additional character attribute and a public character attribute corresponding to the character attribute item meet a preset condition; and generate, in response to the additional character attribute and the public character attribute corresponding to the character attribute item meeting the preset condition, a character attribute corresponding to the character attribute item based on the additional character attribute and the public character attribute; or
generate, in response to the additional character attribute and the public character attribute corresponding to the character attribute item failing to meet the preset condition, the character attribute corresponding to the character attribute item based on the additional character attribute.

In some embodiments, the first determination unit 702 is further configured to: display a character creation page, and determine, in response to a creation operation, at least one newly created character associated with the text content.

In some embodiments, the first generation unit 703 is further configured to:
display, after or during generating the text content, the at least one character on the content editing page, and insert a target character into the text content in response to a selection operation to associate the target character with the text content;
or on the content editing page, insert, after or during generating the text content, the target character into the text content in response to an input operation for a name or an identifier of the target character to associate the target character with the text content.

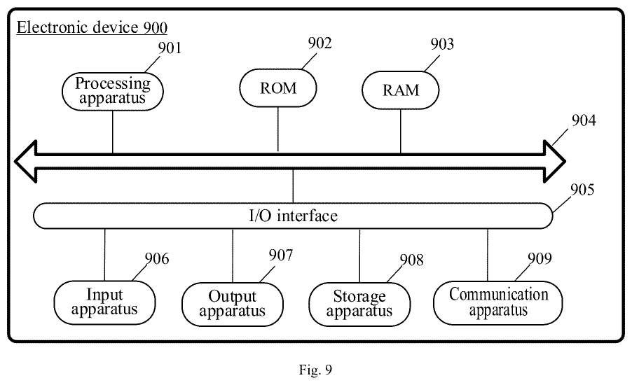

Corresponding to the interactive content display method described above in the embodiment shown in FIG. 6, FIG. 8 is a structural block diagram of an interactive content display apparatus according to an embodiment of the present disclosure. For ease of illustration, only parts related to this embodiment of the present disclosure are shown. Referring to FIG. 8, the apparatus 80 includes: a first display unit 801 and a second display unit 802.

The first display unit 801 is configured to display, in response to receiving a trigger operation performed by a second user on published target interactive content, a display interface of the target interactive content, where the target interactive content is generated from at least one character and text content associated with the at least one character.

The second display unit 802 is configured to display, in the display interface of the target interactive content, information about the target interactive content and at least one target virtual character in the target interactive content, where the at least one target virtual character has a public character attribute, and the target virtual character having the public character attribute supports chatting with a user beyond the target interactive content.

In some embodiments, the apparatus 80 further includes a third display unit (not shown in the figure) configured to:
display a first chat interface independent of the target interactive content in response to receiving an independent chat request initiated by the second user for the target virtual character, where the first chat interface is configured for the second user to have a chat, that is independent of the target interactive content, with the target virtual character.

To implement the above-mentioned embodiments, an embodiment of the present disclosure further provides an electronic device.

FIG. 9 is a schematic structural diagram of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 9 is merely an example, and shall not impose any limitation on the function and scope of use of the embodiments of the present disclosure.

As shown in FIG. 9, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random-access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a magnetic tape and a hard disk; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the shown apparatuses. More or fewer apparatuses may alternatively be implemented or provided.

In particular, according to an embodiment of the present disclosure, the processes described above with reference to the flowcharts may be implemented as a computer software program. For example, this embodiment of the present disclosure includes a computer program product, which includes a computer program carried on a computer-readable medium, where the computer program includes program code for performing the methods shown in the flowcharts. In such an embodiment, the computer program may be downloaded and installed from a network through the communication apparatus 909, installed from the storage apparatus 908, or installed from the ROM 902. When the computer program is executed by the processing apparatus 901, the above-mentioned functions defined in the methods of the embodiments of the present disclosure are performed.

It should be noted that the computer-readable medium described above in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above-mentioned computer-readable medium may be contained in the above-mentioned electronic device. Alternatively, the computer-readable medium may exist independently, without being assembled into the electronic device.

The above-mentioned computer-readable medium carries one or more programs that, when executed by the electronic device, cause the electronic device to perform the methods shown in the above-mentioned embodiments.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowcharts and block diagrams in the accompanying drawings illustrate the possibly implemented architecture, functions, and operations of the system, methods, and computer program product according to various embodiments of the present disclosure. In this regard, each block in the flowcharts or block diagrams may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagrams and/or the flowcharts, and a combination of the blocks in the block diagrams and/or the flowcharts may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a unit does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, an interactive content generation method is provided. The method includes:
displaying a content editing page;
determining at least one character in target interactive content, where the at least one character includes at least one virtual character;
generating, on the content editing page, text content associated with the at least one character;
determining a user character in the at least one character to enable a user to chat with the at least one virtual character according to the user character; and
generating the target interactive content based on the virtual character, the user character, and the text content, and publishing the target interactive content.

According to one or more embodiments of the present disclosure, the determining at least one character in target interactive content includes:
displaying a character import page, where at least one created character is displayed on the character import page; and
determining, in response to a selection operation, the at least one created character associated with the target interactive content.

According to one or more embodiments of the present disclosure, the character includes a character attribute; and
after the determining, in response to a selection operation, the at least one created character associated with the target interactive content, the method further
receiving an additional character attribute of the created character; and
generating the character attribute of the created character in the target interactive content based on at least one of the additional character attribute and a public character attribute of the character.

According to one or more embodiments of the present disclosure, the method further includes:
updating, in response to publishing the target interactive content, the public character attribute of the created character to the character attribute in the target interactive content.

According to one or more embodiments of the present disclosure, the created character has a plurality of character attribute items, the plurality of character attribute items each having a public character attribute; and the additional character attribute includes additional character attributes of one or more character attribute items; and
the generating the character attribute of the created character in the target interactive content based on at least one of the additional character attribute and a public character attribute of the character includes:
determining, for any character attribute item having an additional character attribute, whether an additional character attribute and a public character attribute corresponding to the character attribute item meet a preset condition; and
generating, in response to the additional character attribute and the public character attribute corresponding to the character attribute item meeting the preset condition, a character attribute corresponding to the character attribute item based on the additional character attribute and the public character attribute; or
generating, in response to the additional character attribute and the public character attribute corresponding to the character attribute item failing to meet the preset condition, the character attribute corresponding to the character attribute item based on the additional character attribute.

According to one or more embodiments of the present disclosure, the determining at least one character in target interactive content includes:
displaying a character creation page, and determining, in response to a creation operation, at least one newly created character associated with the text content.

According to one or more embodiments of the present disclosure, the generating, on the content editing page, text content associated with the at least one character includes:
displaying, after or during generating the text content, the at least one character on the content editing page, and inserting a target character into the text content in response to a selection operation to associate the target character with the text content;
or on the content editing page, inserting, after or during generating the text content, the target character into the text content in response to an input operation for a name or an identifier of the target character to associate the target character with the text content.

In a second aspect, according to one or more embodiments of the present disclosure, an interactive content display method is provided. The method includes:
displaying, in response to receiving a trigger operation performed by a second user on published target interactive content, a display interface of the target interactive content, where the target interactive content is generated from at least one character and text content associated with the at least one character; and
displaying, in the display interface of the target interactive content, information about the target interactive content and at least one target virtual character in the target interactive content, where the at least one target virtual character has a public character attribute, and the target virtual character having the public character attribute supports chatting with a user beyond the target interactive content.

According to one or more embodiments of the present disclosure, the method further includes: displaying a first chat interface independent of the target interactive content in response to receiving an independent chat request initiated by the second user for the target virtual character, where the first chat interface is configured for the second user to have a chat, that is independent of the target interactive content, with the target virtual character.

In a third aspect, according to one or more embodiments of the present disclosure, an interactive content generation apparatus is provided. The apparatus includes:
a first display unit, configured to display a content editing page;
a first determination unit, configured to determine at least one character in target interactive content, where the character includes at least one virtual character;

a first generation unit, configured to generate, on the content editing page, text content associated with the at least one character;
a second determination unit, configured to determine a user character in the at least one character to enable a user to chat with the at least one virtual character according to the user character; and
a second generation unit configured to generate the target interactive content based on the virtual character, the user character, and the text content, and publish the target interactive content.

According to one or more embodiments of the present disclosure, the first determination unit is further configured to:
display a character import page, where at least one created character is displayed on the character import page; and
determine, in response to a selection operation, the at least one created character associated with the target interactive content.

According to one or more embodiments of the present disclosure, the character includes character attributes. The first determination unit 702 is further configured to:
receive an additional character attribute of the created character; and
generate the character attribute of the created character in the target interactive content based on at least one of the additional character attribute and a public character attribute of the character.

According to one or more embodiments of the present disclosure, the apparatus further includes an update unit configured to: update, in response to publishing the target interactive content, the public character attribute of the created character to the character attribute in the target interactive content.

According to one or more embodiments of the present disclosure, the created character has a plurality of character attribute items, the plurality of character attribute items each having a public character attribute; and the additional character attribute includes additional character attributes of one or more character attribute items. The first determination unit is further configured to:
determine, for any character attribute item having an additional character attribute, whether an additional character attribute and a public character attribute corresponding to the character attribute item meet a preset condition; and generate, in response to the additional character attribute and the public character attribute corresponding to the character attribute item meeting the preset condition, a character attribute corresponding to the character attribute item based on the additional character attribute and the public character attribute; or
generate, in response to the additional character attribute and the public character attribute corresponding to the character attribute item failing to meet the preset condition, the character attribute corresponding to the character attribute item based on the additional character attribute.

According to one or more embodiments of the present disclosure, the first determination unit is further configured to: display a character creation page, and determining, in response to a creation operation, at least one newly created character associated with the text content.

According to one or more embodiments of the present disclosure, the first generation unit is further configured to:
display, after or during generating the text content, the at least one character on the content editing page, and inserting a target character into the text content in response to a selection operation to associate the target character with the text content;
or on the content editing page, insert, after or during generating the text content, the target character into the text content in response to an input operation for a name or an identifier of the target character to associate the target character with the text content.

In a fourth aspect, according to one or more embodiments of the present disclosure, an interactive content display apparatus is provided. The apparatus includes:
a first display unit, configured to display, in response to a trigger operation performed by a second user on published target interactive content, a display interface of the target interactive content; and
a second display unit, configured to display, in the display interface of the target interactive content, information about the target interactive content and information about at least one target virtual character associated with the target interactive content, where the at least one target virtual character has a public character attribute, and the target virtual character supports chatting with a user beyond the target interactive content.

According to one or more embodiments of the present disclosure, the apparatus further includes a third display unit configured to:
display a first chat interface independent of the target interactive content in response to receiving an independent chat request initiated by the second user for the target virtual character, where the first chat interface is configured for the second user to have a chat, that is independent of the target interactive content, with the target virtual character.

In a fifth aspect, according to one or more embodiments of the present disclosure, an electronic device is provided. The electronic device includes: at least one processor and a memory.

The memory has computer-executable instructions stored therein; and
the at least one processor executes the computer-executable instructions stored in the memory, to cause the at least one processor to perform the methods according to the first and second aspects and various possible designs of the first and second aspects.

In a sixth aspect, according to one or more embodiments of the present disclosure, a computer-readable storage medium is provided. The computer-readable storage medium has stored therein computer-executable instructions, when a processor executes the computer-executable instructions, the methods according to the first and second aspects and various possible designs of the first and second aspects are implemented.

In a seventh aspect, according to one or more embodiments of the present disclosure, a computer program product is provided. The computer program product includes a computer program that, when executed by a processor, causes the methods according to the first and second aspects and various possible designs of the first and second aspects to be implemented.

The foregoing descriptions are merely preferred embodiments of the present disclosure and explanations of the applied technical principles. Those skilled in the art should understand that the scope of the present disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of the present disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An interactive content generation method, comprising:
displaying a content editing page;
determining at least one character in first interactive content, wherein the at least one character comprises at least one virtual character;
generating, on the content editing page, text content associated with the at least one character;
determining a user character in the at least one character to enable a user to chat with the at least one virtual character according to the user character; and
generating the first interactive content based on the virtual character, the user character, and the text content, and publishing the first interactive content.

2. The method according to claim 1, wherein the determining at least one character in first interactive content comprises:
displaying a character import page, wherein at least one created character is displayed on the character import page; and
determining, in response to a selection operation, the at least one created character associated with the first interactive content.

3. The method according to claim 2, wherein the character comprises a character attribute; and
after the determining, in response to a selection operation, the at least one created character associated with the first interactive content, the method further comprises:
receiving an additional character attribute of the created character; and
generating the character attribute of the created character in the first interactive content based on at least one of the additional character attribute and a public character attribute of the character.

4. The method according to claim 3, further comprising:
updating, in response to publishing the first interactive content, the public character attribute of the created character to the character attribute in the first interactive content.

5. The method according to claim 3, wherein the created character has a plurality of character attribute items, each character attribute item of the plurality of character attribute items has a public character attribute, and the additional character attribute comprises additional character attributes of one or more character attribute items; and
the generating the character attribute of the created character in the first interactive content based on at least one of the additional character attribute and a public character attribute of the character comprises:
determining, for any character attribute item having an additional character attribute, whether an additional character attribute and a public character attribute corresponding to the character attribute item meet a preset condition; and
generating, in response to the additional character attribute and the public character attribute corresponding to the character attribute item meeting the preset condition, a character attribute corresponding to the character attribute item based on the additional character attribute and the public character attribute; or generating, in response to the additional character attribute and the public character attribute corresponding to the character attribute item failing to meet the preset condition, the character attribute corresponding to the character attribute item based on the additional character attribute.

6. The method according to claim 1, wherein the determining at least one character in first interactive content comprises:
displaying a character creation page, and determining, in response to a creation operation, at least one newly created character associated with the text content.

7. The method according to claim 1, wherein the generating, on the content editing page, text content associated with the at least one character comprises:
displaying, after or during generating the text content, the at least one character on the content editing page, and inserting a first character into the text content in response to a selection operation to associate the first character with the text content; or
on the content editing page, inserting, after or during generating the text content, the first character into the text content in response to an input operation for a name or an identifier of the first character to associate the first character with the text content.

8. An interactive content display method, comprising:
displaying, in response to receiving a trigger operation performed by a second user on published first interactive content, a display interface of the first interactive content, wherein the first interactive content is generated from at least one character and text content associated with the at least one character; and
displaying, in the display interface of the first interactive content, information about the first interactive content and at least one first virtual character in the target-first interactive content, wherein the at least one first virtual character has a public character attribute, and the first virtual character having the public character attribute supports chatting with a user beyond the first interactive content.

9. The method according to claim 8, further comprising:
displaying a first chat interface independent of the first interactive content in response to receiving an independent chat request initiated by the second user for the first virtual character, wherein the first chat interface is configured for the second user to have a chat, that is independent of the first interactive content, with the first virtual character.

10. (canceled)

11. (canceled)

12. An electronic device, comprising: a processor and a memory,
wherein the memory stores computer-executable instructions; and
the processor executes the computer-executable instructions stored in the memory, to cause the processor to perform an interactive content generation method, and the method comprises:
displaying a content editing page:
determining at least one character in first interactive content, wherein the at least one character comprises at least one virtual character;
generating, on the content editing page, text content associated with the at least one character;
determining a user character in the at least one character to enable a user to chat with the at least one virtual character according to the user character; and
generating the first interactive content based on the virtual character, the user character, and the text content, and publishing the first interactive content.

13. A non-transitory computer-readable storage medium, wherein the non-transitory computer-readable storage medium stores computer-executable instructions, when a processor executes the computer-executable instructions, the method according to claim 1 is implemented.

14. A non-transitory computer-readable storage medium, wherein the non-transitory computer-readable storage medium stores computer-executable instructions, when a processor executes the computer-executable instructions, the method according to claim 8 is implemented.

15. The electronic device according to claim 12, wherein the determining at least one character in first interactive content comprises:
displaying a character import page, wherein at least one created character is displayed on the character import page; and
determining, in response to a selection operation, the at least one created character associated with the first interactive content.

16. The electronic device according to claim 15, wherein the character comprises a character attribute; and
after the determining, in response to a selection operation, the at least one created character associated with the first interactive content, the method further comprises:
receiving an additional character attribute of the created character; and
generating the character attribute of the created character in the first interactive content based on at least one of the additional character attribute and a public character attribute of the character.

17. The electronic device according to claim 16, wherein the method further comprises:
updating, in response to publishing the first interactive content, the public character attribute of the created character to the character attribute in the first interactive content.

18. The electronic device according to claim 16, wherein the created character has a plurality of character attribute items, each character attribute item of the plurality of character attribute items has a public character attribute, and the additional character attribute comprises additional character attributes of one or more character attribute items; and
the generating the character attribute of the created character in the first interactive content based on at least one of the additional character attribute and a public character attribute of the character comprises:
determining, for any character attribute item having an additional character attribute, whether an additional character attribute and a public character attribute corresponding to the character attribute item meet a preset condition; and
generating, in response to the additional character attribute and the public character attribute corresponding to the character attribute item meeting the preset condition, a character attribute corresponding to the character attribute item based on the additional character attribute and the public character attribute; or generating, in response to the additional character attribute and the public character attribute corresponding to the character attribute item failing to meet the preset condition, the character attribute corresponding to the character attribute item based on the additional character attribute.

19. The electronic device according to claim 12, wherein the determining at least one character in first interactive content comprises:
displaying a character creation page, and determining, in response to a creation operation, at least one newly created character associated with the text content.

20. The electronic device according to claim 12, wherein the generating, on the content editing page, text content associated with the at least one character comprises:
displaying, after or during generating the text content, the at least one character on the content editing page, and inserting a first character into the text content in response to a selection operation to associate the first character with the text content; or
on the content editing page, inserting, after or during generating the text content, the first character into the text content in response to an input operation for a name or an identifier of the first character to associate the first character with the text content.

21. An electronic device, comprising: a processor and a memory,
wherein the memory stores computer-executable instructions; and
the processor executes the computer-executable instructions stored in the memory, to cause the processor to perform the interactive content display method according to claim 8.

22. The electronic device according to claim 21, wherein the method further comprises:
displaying a first chat interface independent of the first interactive content in response to receiving an independent chat request initiated by the second user for the first virtual character, wherein the first chat interface is configured for the second user to have a chat, that is independent of the first interactive content, with the first virtual character.
